(19) United States
(12) Patent Application Publication
(10) Pub. No.: US 2012/0298588 A1
(43) Pub. Date: Nov. 29, 2012

(54) REMOVAL OF CONTAMINANTS FROM WATER SYSTEMS

(76) Inventors: Zhixiong Cha, Scotch Plains, NJ (US); Guohua Xiu, Shanghai (CN); Yunhui Deng, Shanghai (CN); Yaping Lu, Shanghai (CN)

(21) Appl. No.: 13/113,118

(22) Filed: May 23, 2011

(51) Int. Cl. B01D 17/035; C02F 1/38; B01D 17/038; C02F 1/52; B01D 17/05

(52) U.S. Cl. 210/704; 210/708; 210/787

(57) ABSTRACT

A method for removing contaminants such as oil and solids from water by feeding a mixture of water containing the contaminants and carbon dioxide to a cyclone; separating water from the mixture; separating a second mixture of oil, carbon dioxide and water from the mixture and feeding the second mixture to a separator wherein oil, carbon dioxide and water are recovered from the separator.

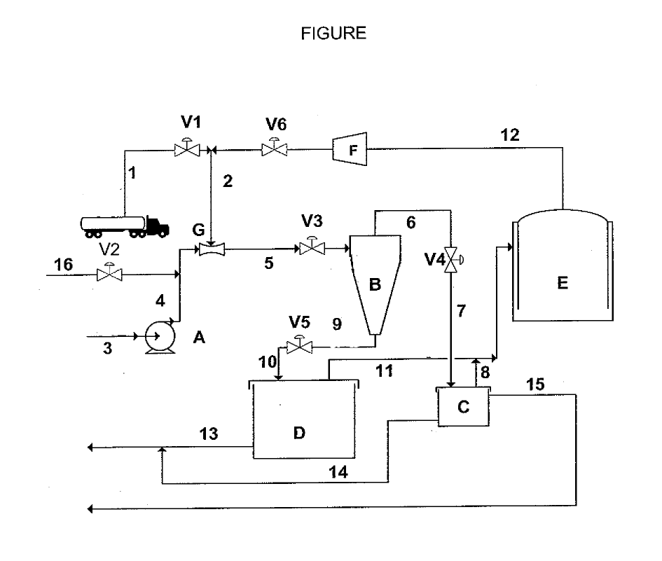

### BACKGROUND OF THE INVENTION

The invention relates to a process in which flotation of dispersed oil in water is accelerated in a hydrocyclone separator by carbon dioxide bubbles that are generated from dissolved carbon dioxide in the oil-bearing water after a pressure drop.

Produced water is the water that is produced with crude oil brought to the surface. On average, more than ten barrels of produced water is generated for each barrel of oil. Produced water normally contains high concentration of super fine oil droplets in the form of emulsions stabilized by surfactants or other emulsifying agents. It is well known that it is difficult to remove oily contaminants from wastewater and other natural and industrial wasters containing oil since de-emulsification and oil extraction from such contaminated water can be particularly challenging. Removal of the emulsified oil in water requires the addition of emulsion breaking reagents such as flocculants. Acidification using an inorganic acid or carbon dioxide to facilitate precipitation of emulsified oil is another effective emulsion breaking process.

Hydrocyclones can be used to separate liquids and solids or liquids of different densities. Because hydrocyclones do not require any pre- or post-treatment of the produced water or any addition of chemicals, they have been used extensively for produced water treatment. Some hydrocyclones can even remove particles in the range of 5 to 15 microns, but hydrocyclones cannot remove dissolved oil and grease components. Flotation is another widely employed method to treat produced water or other oily water. Through the aggregation and flotation effect of fine gas bubbles, flotation can remove small and suspended particles that are difficult to separate by settling or sedimentation. Coagulation reagent can be used as a pretreatment to flotation. Gas flotation technology can be classified into two categories by the method used to generate gas bubbles and the resultant bubble sizes: dissolved gas flotation or DGF and induced gas flotation or IGF. In a DGF process, gas is dissolved in water under elevated pressure and released into a flotation chamber. Upon release, larger amounts of fine gas bubbles 20 to 100 microns in diameter are generated due to rapid pressure drop. The dissolved gas can be air, nitrogen or another type of inert gas such as methane. Dissolved gas flotation can also be used to remove volatile organics and oil and grease if the gas to water volume ratio is high enough. Compared to DGF technology, IGF technology uses mechanical shear or propellers to create bubbles that are introduced into the bottom of the flotation chamber.

The efficiency of the flotation process is affected by the differences in density of liquid and the contaminants to be removed, and the dispersion situation of contaminants such as oil droplet size and temperature. Normally, a low temperature is preferred due to high solubility of gas in the liquid phase and high surface tension of the liquid phase. Also, the gas bubble size and size distribution are critical to the removal efficiency. Removal of particles as small as 3 to 5 microns in size can be achieved by dissolved air flotation or DAF if a coagulation reagent is added for pre-treatment. Further, the total removal of oil can be higher than 93%.

Flotation, however, is not the most effective technology for the removal of dissolved oil from water because the volume ratio of gas to water is mostly lower than 0.15:1 in DAF systems and it is difficult to achieve higher ratios. Another drawback is that the gas-supersaturated water which is forced through needle valves or special orifices to generate bubbles must be fresh water or cleaned water to avoid clogging of such orifices with particles carried in the water. This can increase operating cost of DAF by lowering throughput capacity.

A combined cyclone separation and gas flotation technology called air-sparged hydrocyclone or ASH has circumvented some of these disadvantages of gas flotation technologies. In the air-sparged hydrocyclone, gas is pumped through a porous cylindrical membrane that is coupled to the liquid-liquid hydrocyclone while wastewater is pumped through the hydrocyclone. Because the bubbles are sheared off the wall of the porous membrane due to large centrifugal forces inside the hydrocyclone, much smaller gas bubbles are generated compared to those in DAF. Also the gas flotation effect is not dependent on the gas solubility, so the air to water ratios can be as high as 100:1 to achieve partial removal of the dissolved oil. A concern with ASH is that the low froth concentration in the overflow duo to maintenance of large volumetric overflow rate requires additional treatment steps and the operational parameters of an ASH device are limited by the requirement of obtaining a steady overflow.

To address the operational limitations caused by the traditional stream-splitting approach of hydrocyclones, U.S. Pat. No. 6,171,488 discloses a bubble accelerated flotation technology or BAF evolved from ASH technology. The BAF device consists of a bubble chamber (BC) and a BAF tank. In the BAF process, although coagulation and flocculation of contaminants are completed in the bubble chamber, the generated froth is not ejected through an overflow device. The separation of water and froth is finished in the BAF tank connected to the bubble chamber. Because the BAF process does not incorporate a cleaned-water underflow restriction, operation of the hydrocyclone is more stable. A drawback of the BAF technology is that it requires an additional large flotation tank to separate the aggregated contaminants since the effluent flow is not divided in the hydrocyclone. The treating capacity is determined by the volume of the BAF tank. Another drawback is that this technology has not avoided the fouling problem of the porous membrane. Induced air bubble chamber, vacuum flotation bubble chamber and electro-flotation bubble chamber have been derived from this technology to address this fouling problem. In-situ addition of a coagulant and flocculent can also improve oil removal efficiency.

U.S. Pat. No. 7,638,062 teaches another cyclonic gas flotation process that adds non-soluble gas such as natural gas into produced water before water is tangentially injected into a cyclonic device. The gas bubbles are generated in the water pipeline through a gas disperser to create micro bubbles in the aqueous phase. One drawback of this technology is that the gas bubbles are dispersed in water through mechanical measures rather than through altering the solubility of the gas in the aqueous phase so the gas bubbles are not homogenously generated and small enough to achieve total removal of the emulsified oil. Another drawback is that the volume ratio of gas to water cannot be as high as the ratio in an air-sparged hydrocyclone which is essential for removal of dissolved oil in water.

The relative disadvantages of the above processes can be addressed by the methods of the invention. Carbon dioxide can be dissolved in oil water prior to it entering a cyclone separator. Dissolving carbon dioxide in water provides several advantageous properties to the overall process. Carbon dioxide can partially de-emulsify oily water and reduce the solubility of organics in water by its acidifying effect. Also, after pre-treatment of oily water, carbon dioxide does not require the generation of large amounts of fine bubbles in the cyclone to achieve satisfactory removal efficiency of emulsified oil and dissolved oil. Furthermore, the volume ratio of carbon dioxide to water can be precisely controlled to avoid unstable operation of the cyclone and keep a minimal overflow rate. Because of carbon dioxide's high solubility in water and the relatively simpler structure of the conventional hydrocyclone, the operating cost and construction cost can be greatly reduced. Another advantage of adding carbon dioxide is that it can treat warm and hot produced water. This can be important for the fast treatment of water in some oil fields where the produced water's temperature is higher than the ambient temperature. Since the solubility of carbon dioxide in water is much higher than that of air, direct treatment of warm and hot produced water is possible.

Because some produced water contains high concentrations of chemical additives and metal cations that stabilize emulsion, dissolving carbon dioxide in the water may not achieve the desired coagulation effect. Addition of auxiliary flocculent which works at acidic pH ranges from 3.0 to 6.5 in water may be needed to accelerate coagulation of the emulsified contaminants. Addition of the flocculent is optional and is determined by the treatment requirement. The flocculent is selected from the group consisting of organics such as modified polyacryamides and bioflocculents; inorganics such as ferric sulfate and aluminum sulfate; or combinations of both. Flocculent can be added before or after dissolving of carbon dioxide in the water.

### SUMMARY OF THE INVENTION

A method for removing contaminants from water comprising the steps is disclosed:

a) feeding carbon dioxide to water containing contaminants, wherein the carbon dioxide dissolves in the water;

b) feeding flocculent solution to water containing contaminants and carbon dioxide, wherein the flocculent disperses in the water;

c) feeding the water containing the dissolved carbon dioxide to a cyclone separator;

d) recovering water from the cyclone separator; and

e) recovering oil from the cyclone separator.

The water is typically produced water or industrial process water and the contaminants are selected from the group consisting of oil and solids. The oil may be dissolved oil or emulsified oil.

The water containing carbon dioxide is typically prepared by dissolving carbon dioxide in the water through a venturi device or a mixing valve. The recovered carbon dioxide may be returned to this device for use in introducing carbon dioxide into the water. The resulting mixture typically has a pH of 4 to 7.5.

The flocculent solution is prepared from flocculent that works at acidic pH ranges from 3.0 to 6.5, and is selected from the group consisting of modified polyacryamides, bioflocculents, ferric sulfate, aluminum sulfate, or any combination of them. The optimum effective flocculent dose depends on the contaminants concentration and the nature of contaminants in water.

The method controls the pressure of the water containing the dissolved carbon dioxide prior to entry into the cyclone separator.

The carbon dioxide in the overflow is recovered and is fed to the water containing contaminants through the gas dissolving device.

In another embodiment of the invention there is disclosed a method for removing contaminants from water comprising feeding a mixture of water containing contaminants and carbon dioxide to a cyclone; separating water from the mixture; separating a second mixture of oil, carbon dioxide and water from the mixture and feeding the second mixture to a separator wherein oil, carbon dioxide and water are recovered from the separator.

The contaminants are selected from the group consisting of oil and solids and the water is produced water or process water in refineries and petrochemical plants. The oil may be dissolved oil or emulsified oil. The mixture is present in a tube or line having a length from 0.5 to 100 meters and the pressure of this mixture is controlled prior to entry into the cyclone. The mixture is prepared by inputting the carbon dioxide and any recycled carbon dioxide in water through a device such as a venturi or a mixing valve. The pH of the mixture ranges from 4 to 7.5

In a different embodiment of the invention, there is disclosed a method for removing contaminants from water comprising the steps:

a) feeding a mixture of water containing oil, solids and carbon dioxide to a cyclone;

b) separating water from the mixture;

c) separating a second mixture of oil, carbon dioxide and water from the mixture;

d) feeding the second mixture to a separator; and

e) recovering the oil.

The water may be produced water. The oil may be dissolved oil or emulsified oil. The mixture is present in a tube or line having a length from 0.5 to 100 meters and the pressure of this mixture is controlled prior to entry into the cyclone. The mixture is mixed in a device such as a venturi for inputting the water, the carbon dioxide and any recycled carbon dioxide. The pH of the mixture ranges from 4 to 7.5

### BRIEF DESCRIPTION OF THE DRAWINGS

The FIGURE is a schematic for removing contaminants in water per the invention.

### DETAILED DESCRIPTION OF THE INVENTION

Turning to the FIGURE, a carbon dioxide accelerated de-emulsification and cyclonic flotation process is shown. In this process, carbon dioxide is dissolved in water containing solids and oil, particularly dissolved oil and emulsified oil, through a gas dissolving device or a venturi tube.

Carbon dioxide from a feed source such as a tanker truck or storage tank is fed through line 1 and through open valve V1 to line 2 where it enters a gas dissolving device, G. A pH probe, not shown, may be installed in the pressure pipeline and be used to adjust the pH to a range of 4 to 7.5, particularly 5 to 6.5 by controlling the rate of addition of the carbon dioxide. The pressure of the carbon dioxide pipeline ranges from 100 KPa to 2 MPa, with a range of 150 KPa to 1 MPa preferred. This pressure can in part be controlled by the carbon dioxide compressor F discussed below which helps feed recycled carbon dioxide back to combine with the fresh feed of carbon dioxide. Produced water, which contains dissolved oil and emulsified oil as well as solids is fed through line 3 to water pump A which pressurizes and feeds the produced water through line 4 to gas dissolving device G. Flocculent solution is fed through valve V2 in the produced water. Addition of flocculent in the produced water is optional and its dose depends on the contaminants concentration and the nature of contaminants in water. The carbon dioxide will dissolve in the produced water in gas dissolving device G and be fed through line 5 to pressure control valve V3. The length of line or tube 5 can be from 0.5 meters to 100 meters, with a length of 1 meter to 20 meters preferred. This length will allow sufficient residence time for emulsion breaking and coagulation of oil in the produced water to occur. The pressure control valve V3 will control the hydraulic pressure of the acidified water in line 5. Once the acidified water passes through the pressure control valve V3, micro bubbles can be instantly generated due to the pressure drop. The produced water with carbon dioxide dissolved therein continues through line 5 to cyclone B.

The acidified water will be tangentially introduced into the cyclone where the oil droplets are collected by bubbles and aggregated in the center of the cyclone. The water flow rate between the overflow to the underflow ranges from 0.01:1 to 1:1 with a range from 0.02:1 to 0.2:1 preferred.

In the cyclone B, the solids and the dissolved and emulsified oils are separated. The water will be removed from the cyclone B through line 9 and open valve V5 through line 10 to water tank D. Some carbon dioxide will remain dissolved in the water removed through line 9 as well as having oil droplets contained therein and is recovered from water tank D through line 11 where it is fed into carbon dioxide tank E. The carbon dioxide tank E will feed the recycled carbon dioxide through line 12 to a compressor F and through open valve V6 where it will enter line 2 and begin the process anew by entering the gas dissolving device G.

The separated oil from the cyclone B will, with water (froth) and dissolved carbon dioxide, is fed through line 6 and open valve V4 to line 7 where it will enter the separation tank C. The separation tank is an induced gas flotation tank or a gravimetric flotation tank. Separated water will be removed through line 14 and fed to line 13 where it will be recovered. This separated water may still have residual carbon dioxide present in it and will need to be treated prior to storage as it can be corrosive in such condition. The separated oil will be removed through line 15 and recovered. The dissolved carbon dioxide is captured and fed through line 8 to line 11 where it will be fed to the carbon dioxide tank E and back to the gas dissolving device G as described above.

While this invention has been described with respect to particular embodiments thereof, it is apparent that numerous other forms and modifications of the invention will be obvious to those skilled in the art. The appending claims in this invention generally should be construed to cover all such obvious forms and modifications which are within the true spirit and scope of the present invention.

Having thus described the invention, what we claim is:

1. A method for removing contaminants from water comprising the steps:
a) feeding flocculent solution to water containing contaminants, wherein the flocculent disperses in the water;
b) feeding carbon dioxide to water containing contaminants, wherein the carbon dioxide dissolves in said water;
c) feeding the water containing the dissolved carbon dioxide to a cyclone separator;
d) recovering water from said cyclone separator; and
e) recovering oil from said cyclone separator.

2. The method as claimed in claim 1 wherein said water is selected from the group consisting of produced water and process water in refineries and petrochemical plants.

3. The method as claimed in claim 1 wherein said contaminants are selected from the group consisting of oil and solids.

4. The method as claimed in claim 1 wherein said flocculent solution is prepared from flocculent that is effective at acidic pH ranges from 3.0 to 6.5 in aqueous phase.

5. The method as claimed in claim 1 comprising controlling pressure of the water containing the dissolved carbon dioxide prior to entry into the cyclone separator.

6. The method as claimed in claim 1 wherein said recovered oil contains carbon dioxide.

7. The method as claimed in claim 1 further comprising recovering said carbon dioxide from said oil.

8. The method as claimed in claim 1 wherein said recovered carbon dioxide is fed to water containing contaminants.

9. The method as claimed in claim 1 wherein bubbles are formed in said water containing dissolved carbon dioxide by the pressure control.

10. The method as claimed in claim 9 wherein bubbles are formed in said mixture being introduced into said cyclone separator.

11. The method as claimed in claim 1 wherein said oil is selected from the group consisting of dissolved oil and emulsified oil.

12. The method as claimed in claim 1 wherein said water containing carbon dioxide is mixed in a gas dissolving device.

13. The method as claimed in claim 1 further recovering carbon dioxide.

14. The method as claimed in claim 13 wherein said recovered carbon dioxide is fed to said device.

15. The method as claimed in claim 1 wherein the pH of said water containing carbon dioxide ranges from 4 to 7.5.

16. A method for removing contaminants from water comprising feeding a mixture of water containing contaminants and carbon dioxide to a cyclone;
separating water from said mixture; separating a second mixture of oil, carbon dioxide and water from said mixture and feeding said second mixture to a separator wherein oil, carbon dioxide and water are recovered from said separator.

17. The method as claimed in claim 16 wherein said contaminants are selected from the group consisting of oil and solids.

18. The method as claimed in claim 16 wherein said water is selected from the group consisting of produced water and process water in refineries and petrochemical plants.

19. The method as claimed in claim 16 wherein said mixture is present in a tube having a length from 0.5 to 100 meters.

20. The method as claimed in claim 16 wherein pressure of said mixture is controlled prior to entry into said cyclone.

21. The method as claimed in claim 16 wherein said water recovered from said second mixture is fed to join said water separated from said mixture.

22. The method as claimed in claim 21 wherein bubbles are formed in said mixture being introduced into said cyclone.

23. The method as claimed in claim 17 wherein said oil is selected from the group consisting of dissolved oil and emulsified oil.

24. The method as claimed in claim 17 wherein said mixture is mixed in a gas dissolving device.

25. The method as claimed in claim 24 wherein said recovered carbon dioxide is fed to said device.

26. The method as claimed in claim 16 wherein the pH of said mixture ranges from 4 to 7.5.

27. A method for removing contaminants from water comprising the steps:
a) feeding a mixture of water containing oil, solids, flocculent, and carbon dioxide to a cyclone;
b) separating water from said mixture;
c) separating a second mixture of oil, carbon dioxide and water from said mixture;
d) feeding said second mixture to a separator; and
e) recovering said oil.

28. The method as claimed in claim 27 wherein said water is selected from the group consisting of produced water and process water in refineries and petrochemical plants.

29. The method as claimed in claim 27 wherein said mixture is present in a tube having a length from 0.5 to 100 meters.

30. The method as claimed in claim 27 wherein pressure of said mixture is controlled prior to entry into said cyclone.

31. The method as claimed in claim 27 wherein said water recovered from said second mixture is fed to join said water separated from said mixture.

32. The method as claimed in claim 31 wherein bubbles are formed in said mixture prior to introduction into said cyclone.

33. The method as claimed in claim 27 wherein said oil is selected from the group consisting of dissolved oil and emulsified oil.

34. The method as claimed in claim 27 wherein said flocculent works at acidic pH ranges from 3.0 to 6.5 in aqueous phase.

35. The method as claimed in claim 27 wherein said mixture is prepared by dissolving carbon dioxide in said water in a gas dissolving device.

36. The method as claimed in claim 35 wherein said gas dissolving device is a venturi device.

37. The method as claimed in claim 35 wherein said recovered carbon dioxide is fed to said device.

38. The method as claimed in claim 27 wherein the pH of said mixture ranges from 4 to 7.5.
